(19) United States
(12) Patent Application Publication
(10) Pub. No.: US 2026/0326650 A1
(43) Pub. Date: Oct. 22, 2026

(54) SYSTEM TO MINIMIZE SLOSHING IN TANKER TRUCKS

(71) Applicant: FlexSys, Inc., Ann Arbor, MI (US)

(72) Inventor: Sridhar KOTA, Ann Arbor, MI (US)

(21) Appl. No.: 19/491,549

(22) PCT Filed: Jun. 10, 2024
(86) PCT No.: PCT/US2024/033231

§ 371 Date: Dec. 9, 2025

Related U.S. Application Data
(60) Provisional application No. 63/472,080, filed on Jun. 9, 2023.

(51) Int. Cl. B60P 3/22; B60P 3/24

(52) U.S. Cl. CPC B60P 3/2235; B60P 3/246

(57) ABSTRACT

A system for mitigating sloshing in a transport tank comprises a panel system with first and second panels that can move from a fully open to a fully closed configuration, thereby defining an effective volume within the tank less than the tank's total volume.

### CROSS-REFERENCE TO RELATED APPLICATIONS

This application claims the benefit of and priority under 35 U.S.C. § 119 to U.S. Provisional Patent Application No. 63/472,080, filed Jun. 9, 2023, the contents of which is incorporated herein by reference in its entirety.

### FIELD

The present disclosure pertains to tanker trucks employed for the transport of liquid cargo, specifically addressing systems designed to mitigate sloshing within partially filled tanks to improve vehicular stability and safety during transit.

### BACKGROUND

The field of the present technology pertains to the transport of liquid cargo via tanker trucks, a critical component in the distribution networks of various industries, including those handling fuels, chemicals, acids, and other hazardous materials. The transport process introduces several technical challenges, primarily associated with the stability of the vehicle during transit. The dynamic behavior of liquid cargo within partially filled tanker trucks, manifested as longitudinal (fore and aft) and lateral (side-to-side) oscillations, creates significant safety concerns. Such movement potentially escalates the risk of vehicle rollover or jackknifing, particularly during episodes of sudden acceleration, deceleration, or sharp directional changes. Longitudinal or fore-and-aft movement of the liquid is sometimes referred to as surging, while lateral or sided-to-side movement is sometimes referred to as sloshing, and as used herein sloshing will refer to both longitudinal and/or lateral movement of a liquid in a transport tank.

Tanker trucks are engineered in diverse configurations to accommodate different types of liquid cargo, including specialized trailers for chemical, corrosive, and flammable materials transportation. The capacity of these vehicles varies notably, with chemical trailers typically ranging from 5,500 to 11,600 US gallons. Regulatory constraints, particularly those limiting the gross weight of trucks to 80,000 pounds, further define the design parameters and capacities of tanker trucks. Examples of specific tank types include DOT 406 tanks for low flash point fuels and DOT 407 tanks suited for pressured cargo like soil fumigants and acids.

Transportation of hazardous materials by tanker trucks entails adherence to stringent regulatory standards due to the inherent risks involved. Common hazardous materials include flammable liquids (Class 3), oxidizing substances (Class 5), poisonous substances (Class 6), corrosive substances (Class 8), among others. Statistical data highlights the critical nature of these risks, with over 1,200 tanker truck rollover accidents occurring annually in the U.S. alone, representing 36% of all heavy vehicle highway incidents. These accidents often result from the instability caused by liquid sloshing within partially filled tanks, leading to severe economic, human, and environmental consequences.

Traditional methods to mitigate the adverse effects of liquid movement within tanker trucks involve the use of baffles, namely dividers with perforations designed to reduce fore and aft sloshing. While somewhat effective in addressing longitudinal liquid movement, baffles fail to sufficiently mitigate the lateral movement that fundamentally contributes to vehicle rollovers. Moreover, compartmentalizing tanks to carry different liquid types simultaneously complicates the dynamic behavior further, as compartments may be emptied at different rates, containing varying volumes of liquid and exacerbating sloshing issues.

### SUMMARY

The present disclosure provides systems and methods for mitigating sloshing of liquid within a transport tank that offers significant advancements in the control of liquid dynamics within tanker trucks, enhancing both stability and safety during transit. The disclosed systems and methods address both longitudinal and lateral sloshing and implement adaptable internal structures that can adjust to varying fill levels and cargo types could significantly mitigate the risks associated with liquid transport. Such structures, potentially incorporating advanced materials, configurable designs, and automated systems for real-time adjustments based on cargo and environmental conditions, promise to reduce rollover incidents and contribute to safer and more efficient transportation of liquid cargo.

In one form, the transport tank has a first side wall and a second side wall connected by a bottom wall, and defines a tank interior having a tank volume a central axis. A panel system is disposed within the tank interior and has a first panel attached to the first side wall and a second panel attached to the second sidewall. The first panel and second panels are each operable between a fully open configuration where the first and second panels extend along and adjacent to the first and second side walls, respectively, and a fully closed configuration where the first and second panels have moved towards the bottom wall and overlap each other to define an effective volume between the first and second panels and the bottom wall, the effective volume being less than the tank volume.

In further forms, the system includes an actuation system operably connected to the first panel and the second panel. The actuation system includes an actuator and a band configured to transmit force from the actuator to the respective panel, wherein the actuation system is configured to cause the first and second panels to bend and/or rotate from the fully open configuration towards each other into the fully closed configuration. The actuation system is also preferably configured to cause the first and second panels to bend and/or rotate from the fully closed configuration away from each other into the fully open configuration. The actuation system is preferably mounted to an exterior surface of the transport tank.

According to further forms, the actuation system includes a first band that extends around an outer side of the first and second panels whereby the first and second panels to bend and/or rotate from the fully open configuration towards each other when the actuator tensions the first band. The actuation system may include a second band attached to the first panel and a third band attached to the second panel, whereby the first and second panels bend and/or rotate from a partially closed or fully closed configuration towards the fully open configuration when the actuator tensions the second and third bands. Preferably the second and third bands are attached to the first and second panels at a top edge portion of the first and second panels. A guide may be attached to an interior surface of the first or second side wall of the tank at a location vertically above the central axis. This location is preferably adjacent where a top edge portion of the first or second panel rests alongside the side wall in the fully open configuration. A top edge portion of the first and second panels may define a curved surface for guiding the band. The first and second panels also include opposing ends adjacent the end walls of the tank, the opposing ends each carrying a seal that sliding seals to a respective end wall.

First and second mounting rails may be used to attach the first and second panels to the transport tank. Preferably, the mounting rails are fixedly attached to the first and second side walls, respectively, and extend longitudinally, wherein the first and second panels are attached to the first and second mounting rails. Lower ends of the first and second panels may be fixedly attached to the first and second mounting rails, wherein the first and second panels are configured to bend under tension on the band. The lower ends of the first and second panels may also be rotatably attached to the first and second mounting rails, e.g. by a hinge.

In one form, the actuator includes a prime mover and a spool rotatably driven by the prime mover, the spool receiving the band. When the actuator includes a first band for closing the first and second panels and a second band for opening the first and second panels, the spool may include first and second portions receiving the first and second bands. The first and second bands are preferably wound in opposite directions around the first and second spool portions.

A method for mitigating sloshing of the liquid within a transport tank is also provided. The panel system is disposed within the tank interior and the first and second panels are bent and/or rotated from the fully open configuration towards the partially closed configuration to set the effective volume of the tank interior and reduce space above a top surface of the liquid. The method may include determining a fill percentage of the liquid in the transport tank, and rotating and/or bending the first and second panels based on the fill percentage.

### BRIEF DESCRIPTION OF THE DRAWINGS

FIG. 1 is an isometric view of a prior art tanker truck having a baffle system;

FIG. 2 is an isometric view of a transport tank having a panel system constructed in accordance with the teachings of the disclosure, showing both fully open and fully closed configurations;

FIG. 3 is an isometric view of a panel system in accordance with FIG. 2, showing a fully open configuration;

FIG. 4 is a cross-sectional view of the panel system in FIG. 3;

FIG. 5 is an isometric view of a panel system in accordance with FIG. 2, showing a fully closed configuration;

FIG. 6 is a cross-sectional view of the panel system in FIG. 5;

FIG. 7 is a cross-sectional view of the panel system in FIG. 3 showing the the closing belt with the panels in a fully open configuration;

FIG. 8 is a cross-sectional view of the panel system in FIG. 5 showing the the closing belt with the panels in a fully closed configuration;

FIG. 9 is a is a cross-section view of the panel system in FIG. 5 showing the opening belt with the panels in a fully closed configuration;

FIG. 10 is a cross-section view of the panel system in FIG. 5 showing another embodiment of the opening belt with the panels in a fully closed configuration;

FIG. 11 is a cross-section view of the panel system in FIGS. 3 and 5 showing the panels in various stages between open and closed configurations;

FIG. 12 is a schematic depiction of an actuator forming part of the panel system in FIGS. 3 and 5;

FIGS. 13a, 13b and 13c schematically depict different end formations of the panels of FIGS. 3 and 5; and

FIG. 14 is a chart illustrating slosh reduction potential via the panel system of FIGS. 3 and 5.

FIG. 15 is an enlarged, partially cut-away, cross-sectional view of the panel systems shown in FIGS. 8-10;

FIG. 16 is a side view, partially cut-away, of a transport tank having another embodiment of the panel system;

FIG. 17 is 4 is a cross-sectional view of the panel system similar to FIGS. 3 and 7 but depicting an alternate arrangement for the closing bands.

### DETAILED DESCRIPTION

The disclosed system involves a transport tank 4 having a panel system 7 with one or more morphing panels 8, 9 attached internally to the tank's side walls or annular wall 5.

Upon activation, the panels bend and/or unfold toward the tank's center, reducing the available dead space where sloshing typically occurs. As discussed further below, various stages of panel movement relative to different fill levels, effectively illustrating the conversion from substantial dead space to minimal dead space conditions. Possible panel materials include steel, aluminum, or composites chosen based on liquid compatibility. Design considerations include sufficient structural integrity to withstand dynamic loads without excessive actuation forces. Panels can be optimized via sectional variations and reinforcements like ribs. They are also robust enough for maintenance operations and bending without risking deformity. Importantly, the integration of these morphing panels has no lateral displacement effect on the tanker's center of gravity (CG). This measure ensures the vertical CG plane remains centered, thereby averting additional instability.

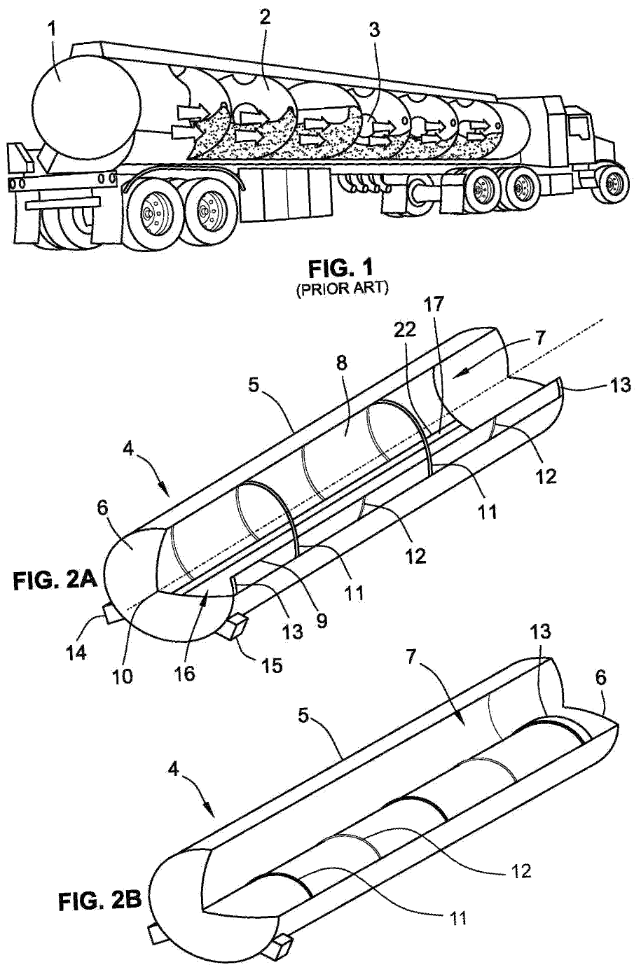

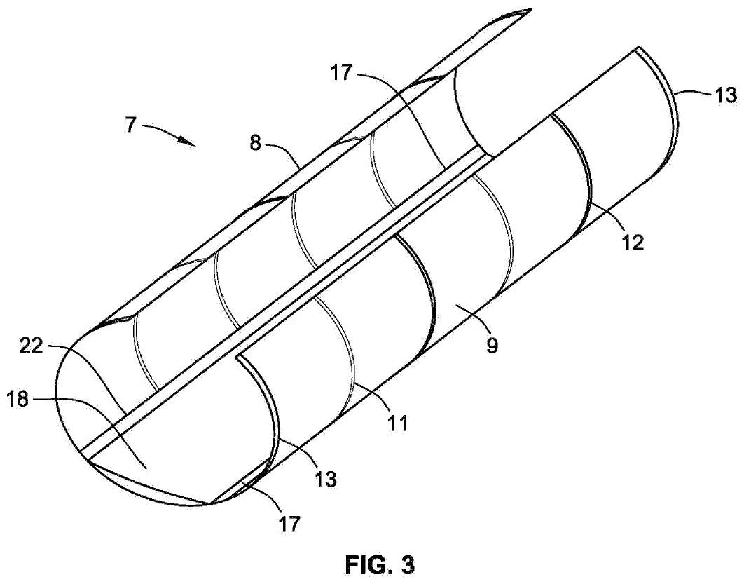

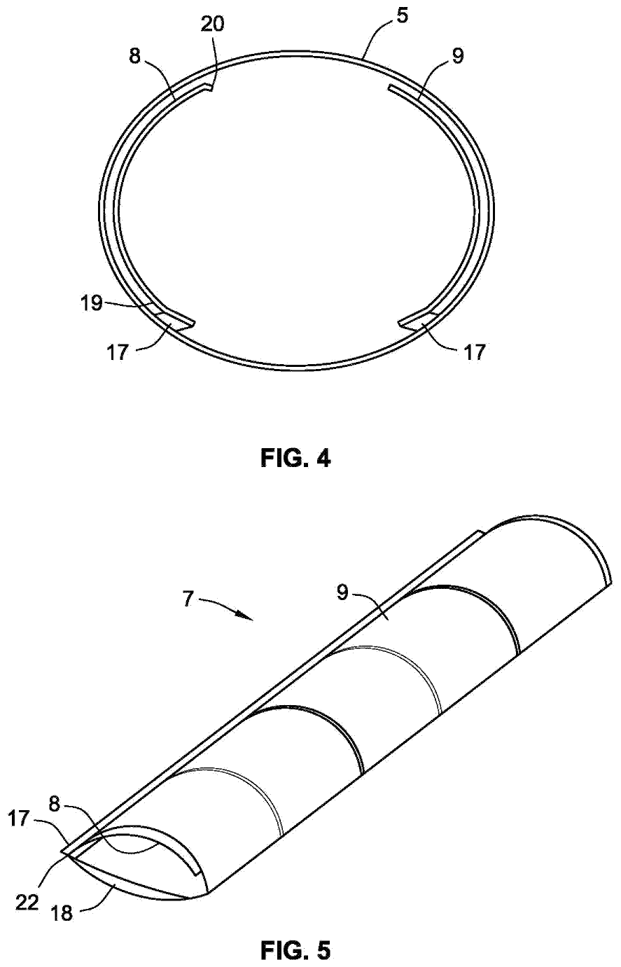

Turning to FIGS. 2-5, the panel system 7 generally includes a driver's side or left panel 8 and a passenger's side or right panel 9. The panels are mounted to opposite sides of the interior of the transport tank 4 (i.e. relative to central axis 10), and namely affixed to the annular wall 5 and extending longitudinally between the tank's end walls 6. The panels are preferably affixed using mounting rails 17 that attached to the interior of the transport tank 4 via fasteners or material bonding (adhesives, welding, soldering or variations thereof). The mounting rails 17 extend along opposing side portions of annular wall 5 below the central axis 10 and generally located toward the tank's lower portion. A lower edge portion or lower end 19 of the panels 8, 9 is rigidly attached to the mounting rails 17 via force fit, fasteners or material bonding, or rotatably attached using a hinge 22. An upper edge portion or upper end 20 of the panels 8, 9 are free to permit rotation and/or bending of the panels 8, 9.

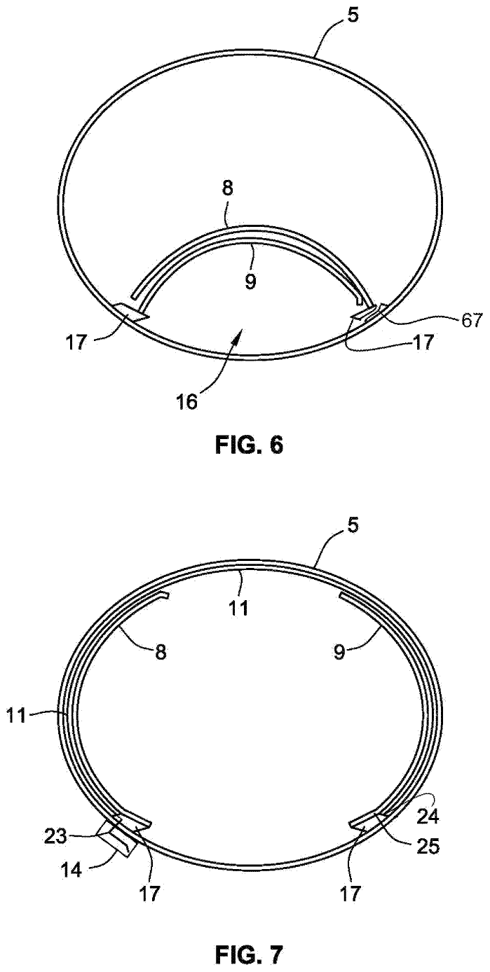

When the tanker is not in operation or fully loaded, the panels adhere to the tank's interior contours and take a fully open configuration as shown in FIGS. 2A, 3 and 4. The panels 8, 9 bend and/or rotate about hinge 22 towards each other and overlap in a fully closed configuration shown in FIGS. 2B, 5 and 6. As best seen in FIG. 6, the overlapping panels 8, 9 define an effective volume 16 of the tank 4 that is significantly smaller than the total volume of the tank 4. The space between the panels at their highest extension (i.e. between upper edge portions) allows for the accommodation of standard tank filling apparatus. The ends of the panels 8, 9 include sliding seals 13 such as a windshield wiper-type to seal against the end walls 6. Since the end walls 6 typically have a curvature, the seals 13 may be generally triangular or wedge-shaped with a curved side to correspond to the wall curvature. In this way, effective sealing is maintained at the panel ends to limit liquid seepage. Perfect sealing is not required, and any seepage will generally rest near the bottom of the tank and hence will not adversely affect the reduction in liquid sloshing. As shown in FIG. 6, the mounting rail 17 may include a drain hole 67 to permit fluid to drain back to the effective volume 16, and have a one-way valve fitted therein. A lower end of the panel, i.e. adjacent the mounting rail 17, may also include such a drain hole.

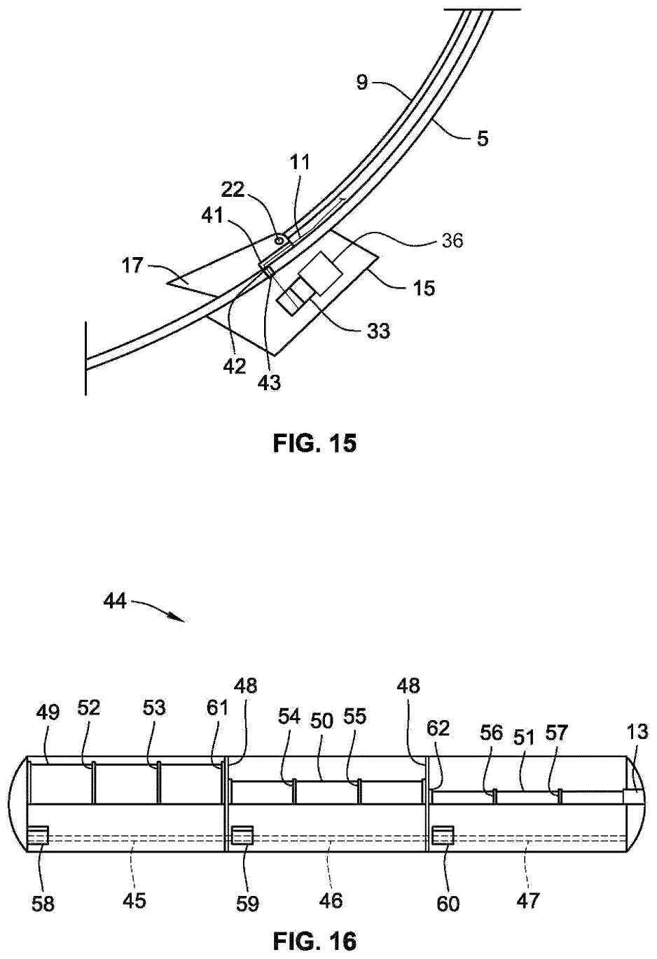

With reference to FIGS. 2A and 2B, an actuating system generally includes at least one actuator for each panel, shown in the figures as left actuator 14 and right actuator 15, and tension elements (e.g. cables or bands) that transmit force from the actuators 14, 15 to the panels 8, 9. The network of tension elements preferably include steel or composite wires, controlled by the one or more actuators 14, 15 positioned externally on the transport tank 4. As one example, the bands 11, 12 may be routed using guides, pulleys, rings, grommets or the like along the interior of the tank wall 5 and exterior sides of the panels, and down to the mounting rail 17. The mounting rail 17 can include passageways 41 for the bands to direct them through one or more openings 42 in the tank 4 having a sliding seal 43 that sealing engages an end of the opening 41 as the band 11/12, as shown in FIG. 15. The bands extend through the openings 42 and seals 43 to the actuators 14, 15. FIG. 15 depicts the closing band 11 operably connected to the right actuator 15, and similar structures may be used for the opening band 12 and the left actuator 14.

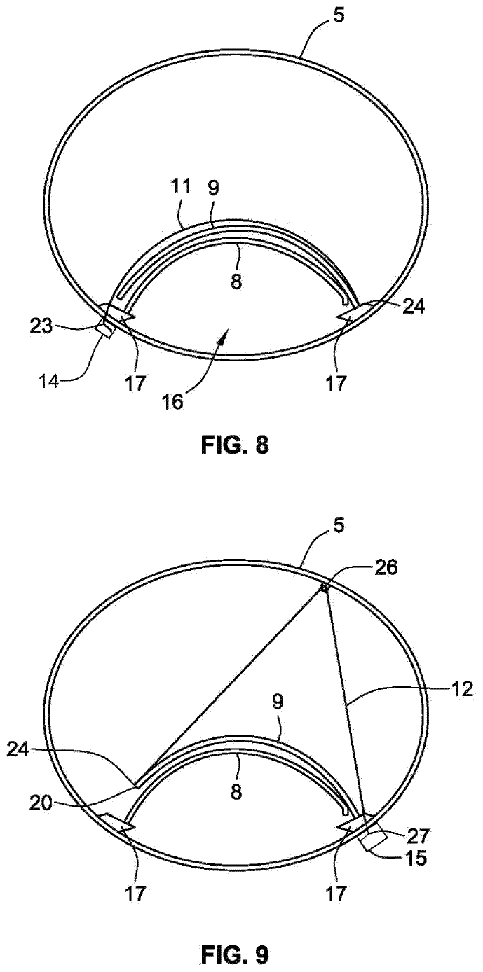

As best seen in FIG. 2, each panel 8, 9 includes a closing band 11 and an opening band 12. Multiple bands 11, 12 may be used depending on the length and weight of the panels 8, 9. The closing bands 11 wrap around the exterior of the panels 8, 9 to locations adjacent the lower ends 19 of the panels and/or the mounting rails 17. As shown in FIG. 7, a distal end 24 of the closing band is fixedly attached at a fixed point 25 to the tank wall 5, the mounting rail 17, and/or the lower end 19 of the panels 8, 9, while the proximal end 23 of the closing band is fitted through the tank wall and operably engaged with an actuator, e.g. left actuator 14. As best seen in FIGS. 7 and 8, tension on the closing bands 11 via the actuator draws in the band and reduces its length inside the tank 4, thereby bending and/or rotating the panels 8, 9 towards each other and the fully closed position. Bending or morphing of the panels allows their radius of curvature to decrease so that they fit together in an overlapped configuration which reduces the effective volume 16 for fluid in the tank 4, however the panels 8, 9 may also just merely rotate between positions, e.g. via a hinge 22 which can be a traditional hinge, a living hinge or the like.

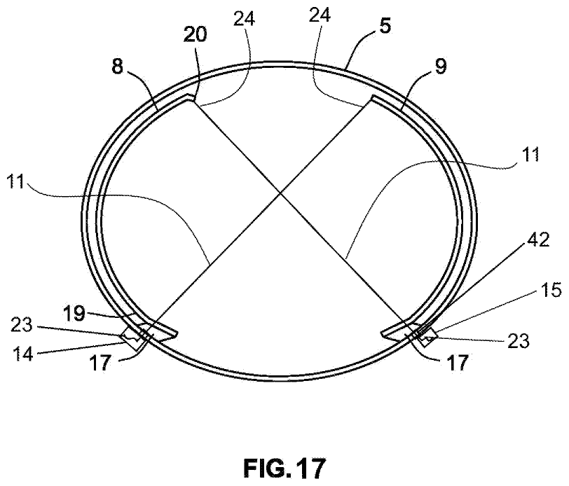

Other arrangements of the closing bands 11 are also possible. In one variation shown in FIG. 17, two closing bands 11 are attached to the upper ends 20 of the panels 8, 9, respectively, and extend across the tank to the opposite side where they are routed through the tank wall 5 to the actuators 14, 15. In this way, the left panel 8 and right panel 9 may be independently actuated. When multiple closing bands 11 are used for one panel, they may be routed via rings or pulleys to a common location and joined together, so that a single strand is then fed through the wall 5 to an actuator 14, 15. Similar networks of bands may also be used for the opening bands 12 when multiple are used for a single panel. Likewise, while the actuators are shown on the annular wall 5, they may also be mounted to the exterior of either or both of the end walls 6 (FIG. 2A), e.g. at a location where the mounting rail 17 meets the end walls 6. The mounting rail 17 preferably has openings and passageways for the bands 11, 12 that link to openings in the annular wall 5 or end wall(s) 6 of the tank 4.

It will be also recognized by the skilled person that the opening bands 12 may be eliminated through the design of the panels 8, 9. In particular, the panels may be configured to naturally take their fully open configuration, bend via the closing band(s) 11 towards the fully closed configuration, and upon the release of tension on band(s) 11 return naturally under its own spring bias to the fully open configuration. Selection of material and dimensions of the panels (e.g. thickness) and reinforcing bars can be tuned for this functionality. Likewise, the panels 8, 9 may have a variable stiffness or flexibility, again through material selection and dimensioning, e.g. by varying the thickness from the upper end to the lower end of the panels 8, 9.

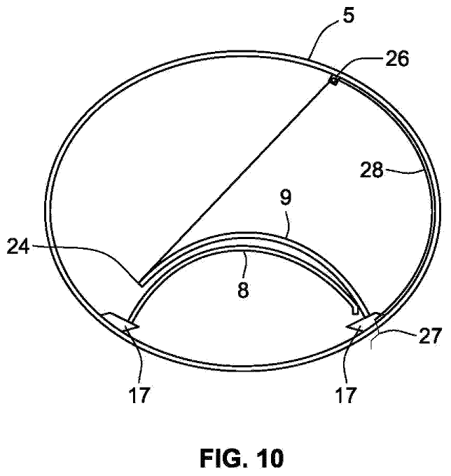

The opening bands 12 have their distal ends 27 are affixed to an upper edge portion or upper end 20 of a respective panel 8, 9. The opening bands 12 extend along the exterior side of the panels 8, 9 on their respective sides, where they are passed through the tank wall 5 in a fashion similar to the closing bands 11. The opening bands 12 are let out from the actuators 14, 15 as the panels 8, 9 move towards their fully closed position, and hence tension on the closing bands 11 (by drawing them in via the actuator) reduces their length inside of the tank 4 to rotate the panels 8, 9 upwardly to their fully open configuration. As shown in FIG. 9, a pulley or guide ring 26 may be affixed to the interior of the annular wall 4 at a location near the upper half of the tank 5 where the panel's upper end 20 rests in the fully open position. As shown in FIG. 10, a cable routing channel 28 can also be used to route the cables or bands 12 along the annular wall 4 and behind the panels 8, 9 in their open position. An open upper end of the channel 28 forms a cable guide 26 for smooth sliding of the opening bands 12.

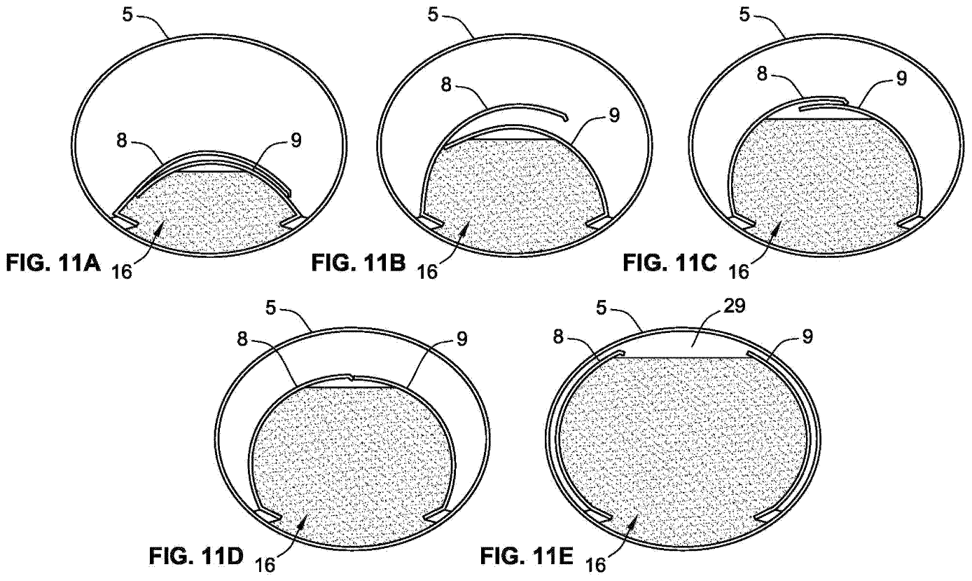

As shown in FIGS. 13A-13C, the upper ends 20 of the panels 8, 9 may have various features to facilitate the described functionality. The upper ends 20 may include a hole 36 for either affixing a band (e.g. opening band 12), or for guiding a band therealong (e.g. closing band 11), as shown in FIG. 13A. The upper ends 20 preferably also include a seal or gasket 39 so that one of the panels 8 or 9 seals against the other as they overlap and move towards a fully closed configuration (see, e.g. FIGS. 11A-11E). The upper ends 20 may also be rolled 38 (FIG. 13C) or include a round (see, e.g. gasket 39 in FIG. 13B which could also be other shapes)) to allow a band to slide smoothly over the edges formed by the upper ends 20, as well as to facilitate one panel sliding along the other and sealing as they overlap in partially closed and fully closed positions.

As shown in FIG. 15, the actuators 14, 15 are preferably mounted on the exterior of the annular wall 5 of the transport tank 4. The bands 11, 12 may be routed through openings 42 in the wall 5 which contain a sliding seal 43 and leads to the spool 33 or other effectuators of the actuators 14, 15. In one form, the mounting rail 17 may include one or more internal passageways 41 for directing the bands 11, 12 from the interior to the exterior of the tank 4 for attachment to the winch or other actuator. That is, similar passageways to passageway 41 shown in FIG. 15 may formed at a different location (e.g. longitudinally spaced apart) so that each band has a devoted passageway through the rail 17 and/or tank 4.

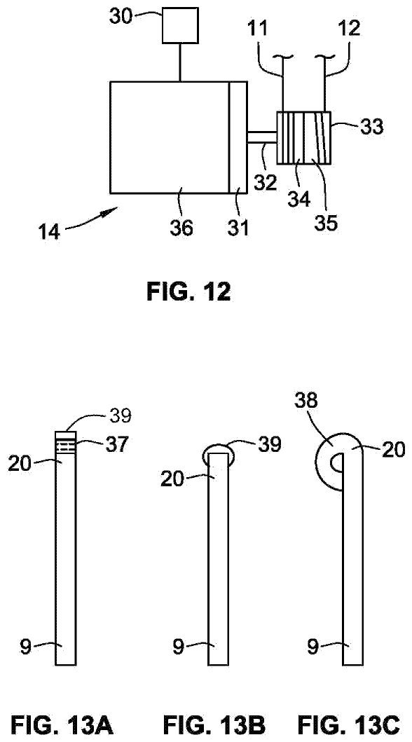

As shown in FIG. 12, the actuators 14, 15 may include a prime mover 36 such as a motor, cylinder, hand crank or combinations thereof. A control unit 30 such as a microprocessor or circuit may be used to control the prime mover 36 and communicate with the vehicle, its operator or a command station. A transmission 31 may also be used to gear up or down the output of the prime mover 36. In one example, a shaft 32 may be driven to rotate a spool 33. Since the opening band 12 needs to be let out as the closing band 11 is drawn in (wound around the spool) during closing of the panels (and vice versa for opening of the panels), the spool 33 can include a closing spool portion 34 for the closing band 11 and an opening spool portion 35 for the opening band 12, where the spool portions 34, 35 rotate together. Hence, the bands 11, 12 should be wound in different directions (e.g. one clockwise, one counter-clockwise) around their respective spool portions. If different rates of movement are desired for the closing band 11 and the opening band 12, the transmission 31 or another transmission may be included as part of the spool 33, or downstream as part of the network of bands 11, 12 (e.g. via pulley systems or the like).

The actuators preferably comprise a winch system, which can be hydraulic or electric or function manually depending on the particular application. For increased safety, motorized components are preferably located externally to evade potential sparking. Actuation control systems can be manual, powered, or both. In powered mode, operators utilize motor mechanisms to engage panels as needed. Automatic operation might be enabled for critical conditions where sensors detect and adjust panel positions to minimize sloshing. Additionally, manual overrides are available to prevent system failings from causing structural damage. Pre-set or operator-controlled algorithms can be used to configure the system to maintain desired slosh conditions based on liquid type, volume, and environmental parameters.

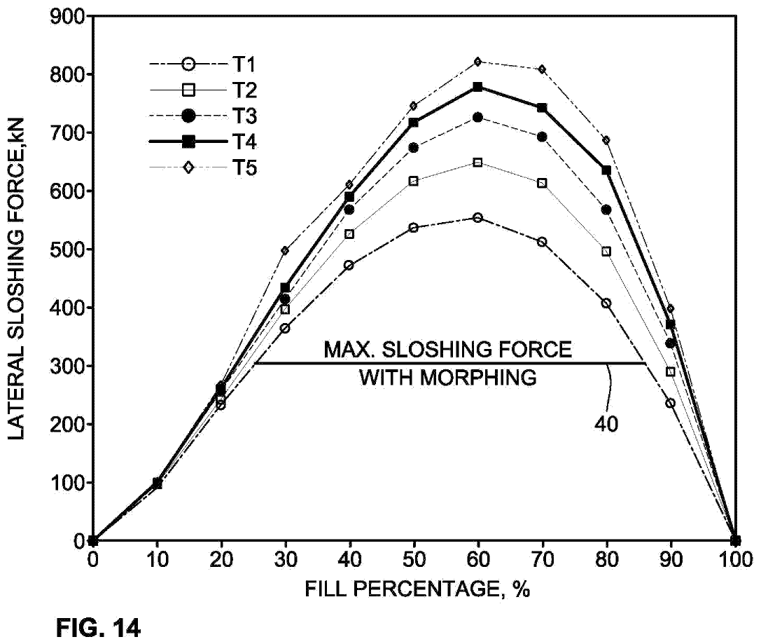

As best seen in FIG. 11, the panels 8, 9 may be positioned in any stage between fully open and fully closed through operation of the actuators 14, 15 and the bands 11, 12. The panels 8, 9 bend and/or unfold toward the tank's center, reducing the available dead space where sloshing typically occurs, and preferably keeps the dead space to 20% or less of the tank's total volume. FIG. 11 shows various stages of panel movement relative to different fill levels, effectively illustrating the conversion from substantial dead space to minimal dead space conditions. The fill state of the tank 4 may be known through individual observation, sensors in the tank, or sensors in the actuators that detect resistance to closing of the panels. In this way, both longitudinal and lateral sloshing of fluid in the transport tank 4 is greatly reduced. For example, as shown in FIG. 14, the maximum sloshing force is depicted by lines T1-T5 over different fill percentages. FIG. 14 is adapted from Zhang et al, “Rollover stability analysis of tank vehicles based on the solution of liquid sloshing in partially filled tanks”, Advances in Mechanical Engineering 2017, Vol. 9(6) 1-26. T1-T5 represent different elliptical tank shapes where the ratio of long axis “a” and short axis “b” of elliptical tank cross sections changes from 1.0 to 2.0 with a step size of 0.25. T1 corresponds to a/b=1 (circular tank) and T5 corresponds to a/b=2. In all these cases, the sloshing forces increase significantly when the tank is partially filled between approximately 30% and 80%. Note that tanks filled to full capacity do not pose high sloshing forces since the dead space is minimal for sloshing to take place. On the other extreme, when the tank is less than about a third full, even though there is ample dead space, the amount of liquid in the tank is not sufficient to cause high slosh forces leading to lateral instability and roll-over. Therefore, it is important that the sloshing forces be minimized at fill percentages between 35% and 80%. The horizontal line in FIG. 14 indicates potential reduction in sloshing forces afforded by the present disclosure having morphing panels inside a tanker. Sloshing forces can be reduced to one-third of the peak and to a level where sloshing forces are not significant enough to cause lateral instability and rollover accidents, e.g. at 300 kN.

It will also be recognized by those skilled in the art that the panel system 7 may be adapted for differently sized and shaped transport tanks. For example, FIG. 16 depicts a tank 44 having three sections 45, 46, 47, e.g. for three different liquids. The sections 45-47 are separated by walls 48, and the walls 48 could also form baffles in the tank 44 if only a single fluid is loaded for transport. Each section 45, 46, 47 includes its own set of left and right panels 49, 50, 51, closing bands 52, 54, 56, opening bands 53, 55, 57 and actuators 58, 59, 60. The panels 49, 50, 51 can include a seal 13 as in the prior embodiments and/or a shorter seal 61, 62 for sealing against the barrier walls 48. In instances where the tank is segmented for transporting various liquid types, the morphing panels can adapt to each compartment independently, factoring in differing fill levels and liquid properties.

The system is inherently adaptable in scope. The number and size of panels can vary with tanker dimensions, and actuators may be positioned as needed. Panels are capable of morphing through flexible adjustments or rotational hinges based on structural requirements. In essence, the application of morphing panels presents a technologically advanced method for addressing the critical issue of liquid sloshing in tanker trucks, thereby significantly enhancing vehicular safety and operational stability. The panels' adaptable design and control flexibility cater to a wide range of operational scenarios, providing a robust and efficient solution to a longstanding problem in liquid transport.

1. A system for mitigating sloshing of liquid within a transport tank, comprising:
a transport tank having a first side wall and a second side wall connected by a bottom wall, the transport tank defining a tank interior having a tank volume a central axis; and
a panel system disposed within the tank interior and having a first panel attached to the first side wall and a second panel attached to the second sidewall, the first panel and second panel each operable between a fully open configuration where the first and second panels extend along and adjacent to the first and second side walls, respectively, and a fully closed configuration where the first and second panels have moved towards the bottom wall and overlap each other to define an effective volume between the first and second panels and the bottom wall, the effective volume being less than the tank volume.

2. The system of claim 1, further comprising an actuation system operably connected to the first panel and the second panel, the actuation system including an actuator and a band configured to transmit force from the actuator to the respective panel, wherein the actuation system is configured to cause the first and second panels to bend and/or rotate from the fully open configuration towards each other into the fully closed configuration.

3. The system of claim 2, wherein the actuation system is configured to cause the first and second panels to bend and/or rotate from the fully closed configuration away from each other into the fully open configuration.

4. The system of claim 2, wherein the actuation system is mounted to an exterior surface of the transport tank.

5. The system of claim 2, wherein the actuation system includes a first band that extends around an outer side of the first and second panels whereby the first and second panels to bend and/or rotate from the fully open configuration towards each other when the actuator tensions the first band.

6. The system of claim 5, wherein the actuation system includes a second band attached to the first panel and a third band attached to the second panel, whereby the first and second panels bend and/or rotate from a partially closed or fully closed configuration towards the fully open configuration when the actuator tensions the second and third bands.

7. The system of claim 6, wherein the second and third bands are attached to the first and second panels at a top edge portion of the first and second panels.

8. The system of claim 6, further comprising a guide attached to an interior surface of the first or second side wall of the tank at a location vertically above the central axis.

9. The system of claim 8, wherein the location is adjacent where a top edge portion of the first or second panel rests alongside the side wall in the fully open configuration.

10. The system of claim 2, wherein a top edge portion of the first and second panels defines a curved surface for guiding the band.

11. The system of claim 1, wherein the tank includes end walls, and wherein the first and second panels include opposing ends adjacent the end walls, the opposing ends each carrying a seal that sliding seals to a respective end wall.

12. The system of claim 2, further comprising first and second mounting rails fixedly attached to the first and second side walls, respectively, and extend longitudinally, and wherein the first and second panels are attached to the first and second mounting rails.

13. The system of claim 12, wherein lower ends of the first and second panels are fixedly attached to the first and second mounting rails, and wherein the first and second panels are configured to bend under tension on the band.

14. The system of claim 12, wherein lower ends of the first and second panels are rotatably attached to the first and second mounting rails.

15. The system of claim 2, wherein the actuator includes a prime mover and a spool rotatably driven by the prime mover, the spool receiving the band.

16. The system of claim 15, wherein the actuator further includes a first band for closing the first and second panels, and a second band for opening the first and second panels, and wherein the spool includes first and second portions receiving the first and second bands, the first and second bands being wound in opposite directions around the first and second spool portions.

17. The system of claim 1, wherein an annular wall of the transport tank defines the opposing side walls.

18. The system of claim 2, wherein the first and second panels are independently actuated from the fully open configuration towards the fully closed configuration.

19. A method for mitigating sloshing of the liquid within a transport tank having a first and second side walls defining a tank volume, the method comprising:
disposing a panel system within the tank interior having a first panel attached to the first side wall and a second panel attached to the second sidewall, the first panel and second panel each operable between a fully open configuration where the first and second panels extend along and adjacent to the first and second side walls, respectively, and a fully closed configuration where the first and second panels have moved towards the bottom wall and overlap each other to define an effective volume between the first and second panels and the bottom wall, the effective volume being less than the tank volume;
rotating and/or bending the first and second panels from the fully open configuration towards the partially closed configuration to set the effective volume of the tank interior and reduce space above a top surface of the liquid.

20. The method of claim 19, further comprising the step of determining a fill percentage of the liquid in the transport tank, and wherein the step of rotating and/or bending the first and second panels is conducted with consideration of the fill percentage.
